(19) United States
(12) Patent Application Publication
(10) Pub. No.: US 2009/0085865 A1
(43) Pub. Date: Apr. 2, 2009

(54) DEVICE FOR UNDERWATER USE AND METHOD OF CONTROLLING SAME

(75) Inventor: Eric Abdel FATTAH, Vancouver (CA)

Correspondence Address: BORDEN LADNER GERVAIS LLP, 1200 WATERFRONT CENTRE, 200 BURRARD ST., P.O. BOX 48600, VANCOUVER, BC, V7X 1T2, CA

(73) Assignee: LIQUIVISION PRODUCTS, INC., Burnaby (CA)

(21) Appl. No.: 12/212,286

(22) Filed: Sep. 17, 2008

Related U.S. Application Data
(60) Provisional application No. 60/975,662, filed on Sep. 27, 2007.

(51) Int. Cl. G09G 5/00; G01L 19/08

(52) U.S. Cl. 345/156; 702/139

(57) ABSTRACT

A method of controlling a device for underwater use includes detecting a user-interaction with the electronic device based on signals received from an accelerometer, and performing an operation as a result of the user-interaction.

### REFERENCE TO RELATED APPLICATIONS

The present application claims the benefit of priority of provisional patent application No. 60/975,662, filed on Sep. 27, 2007, which is incorporated herein by reference.

### TECHNICAL FIELD

The present application relates to a user-interface and input for underwater diving devices.

### BACKGROUND DISCUSSION

Humans who dive underwater often require the use of specialized devices, such as wrist-worn diving devices, while diving. These devices can be used to provide information to the diver, such as depth, time underwater, distance traveled, current position, water temperature, communication information, directional heading, acoustic or visual alarms, or other information. Frequently, these devices are electronic in nature. Divers must often interact with these devices to view various information, to change various settings, or to queue the device to measure or perform various tasks. The classical method of interacting with underwater devices is by means of buttons. Buttons, although sometimes suitable in above-water applications, present numerous problems underwater. Divers often must wear extremely thick gloves, making pressing buttons difficult. Further, buttons must interact with both the electronic circuit and be accessible by the user while being insulated from water in order to function properly. This presents numerous engineering challenges that make underwater buttons difficult and expensive to manufacture. It will be appreciated that the use of buttons causes a risk of flooding and failure of the device. As a result, existing underwater devices often use a small number of buttons to reduce cost and complexity. Fewer buttons means that interacting with a device becomes more complicated and less intuitive, as the diver must push the buttons in complicated sequences to accomplish the desired tasks. Since divers often suffer impaired mental functioning due to nitrogen narcosis or other pressure or temperature induced physiological changes, memory recall can be impaired, making the recall of special button pressing sequences difficult or impossible. Further, engineering challenges make underwater buttons difficult to push and therefore excessive force is often required.

It is therefore an object of an aspect to obviate or mitigate at least one disadvantage of the prior art.

### SUMMARY

According to one aspect, there is provided a method of controlling a device for underwater use. The method includes detecting a user-interaction with the device based on signals received from an accelerometer, and causing a visible change to the device as a result of the user-interaction.

According to another aspect there is provided a device for underwater use. The device includes a housing, a display device framed by the housing, an accelerometer housed in the housing and a controller connected to the accelerometer and the display device and housed in the housing. The controller is operable for receiving signals from the accelerometer, determining a user-interaction event based on the signals received from the accelerometer; and causing a change the display device as a result of the interaction event. Other aspects and features of the will become apparent to those ordinarily skilled in the art upon review of the following description of specific in conjunction with the accompanying figures.

### BRIEF DESCRIPTION OF THE DRAWINGS

Embodiments of the present application will now be described, by way of example only, with reference to the attached Figures, wherein:

FIG. 1 is a simplified block diagram showing components of an electronic device according to one aspect of an embodiment;

FIG. 2 is a plan view of an exemplary electronic device according to an embodiment;

FIG. 3 is a perspective view of a portion of the electronic device of FIG. 2, drawn to a larger scale;

FIG. 4 is an exemplary graph of acceleration vs. time for a tap interaction with the electronic device of FIG. 1;

FIG. 5 shows the graph of FIG. 4 correlated with a single square wave kernel;

FIG. 6 shows the graph of FIG. 4 compared to a boundary value for tap detection;

FIGS. 7 to 9 show exemplary screen shots of the underwater device of FIG. 2; and

FIG. 10 is a flow chart illustrating steps in a method of controlling electronic device according to one embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The present invention relates to a user-interface and input for electronic devices for use in underwater diving such as electronic wrist-worn diving computers. Such diving computers are waterproof or water resistant and may be used for monitoring any one or a combination of depth, time underwater, distance traveled, current position, water temperature, communication information, directional heading, acoustic or visual alarms, or other information.

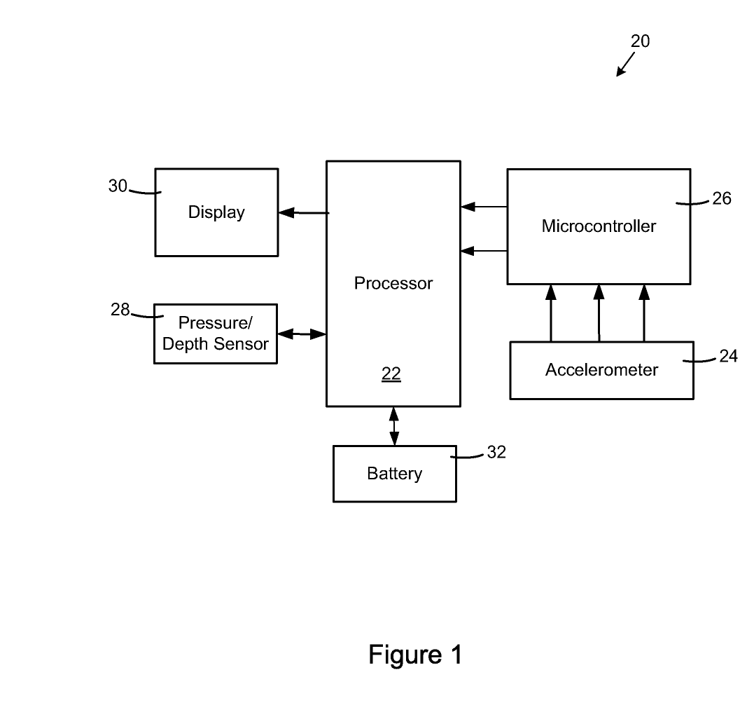

Referring to FIG. 1, there is shown therein a block diagram of an exemplary embodiment of an electronic device for underwater use, indicated generally by the numeral 20. The electronic device 20 includes a number of components such as the microprocessor 22, or main controller, that controls the overall operation of the electronic device 20. The microprocessor 22 is connected to a user-interaction detection arrangement for detecting a tap on the electronic device 20. The user-interaction detection arrangement includes an acceleration sensor (accelerometer) 24 connected to a microcontroller 26. The microcontroller 26 receives signals from the acceleration sensor 24 in response to a user-interaction in the form of a tap and determines the type of tap and sends a signal to the microprocessor 20.

The microprocessor 20 also interacts with a pressure sensor 28 for reading pressure information and calculating a diver's depth and dive time.

A display such as an organic light emitting diode (OLED) display 30 is also connected to the microprocessor 20, for providing display screens in a graphical user interface.

The electronic device 20 is a battery-powered device and includes a battery 32 for providing power to the other components of the electronic device 20.

As indicated above, the electronic device 20 includes the microcontroller 26, and the acceleration sensor 24, which can be a 3-axis acceleration sensor (accelerometer). The acceleration sensor 24 outputs analog or digital values proportional to the acceleration along the three cardinal directions (arbitrarily denoted x, y, and z). The microcontroller 26 receives and/or digitizes the three values, repeatedly. These three values, sampled repeatedly over time, produce three signals, corresponding to the x, y and z acceleration vectors respectively.

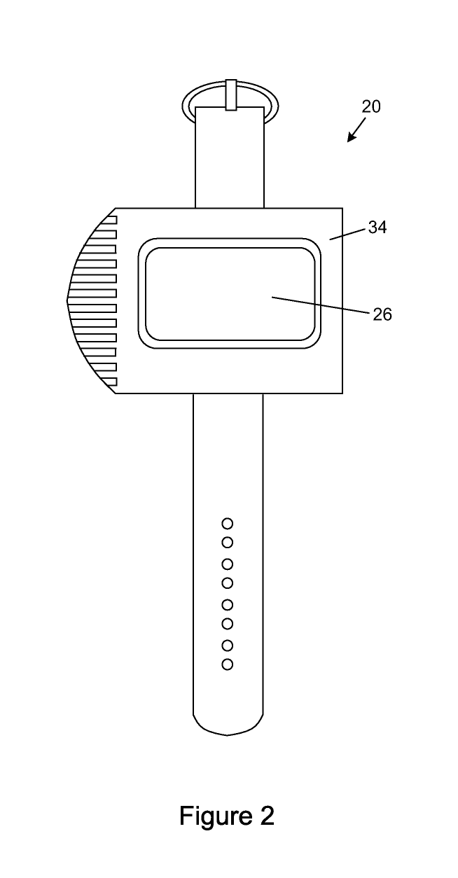

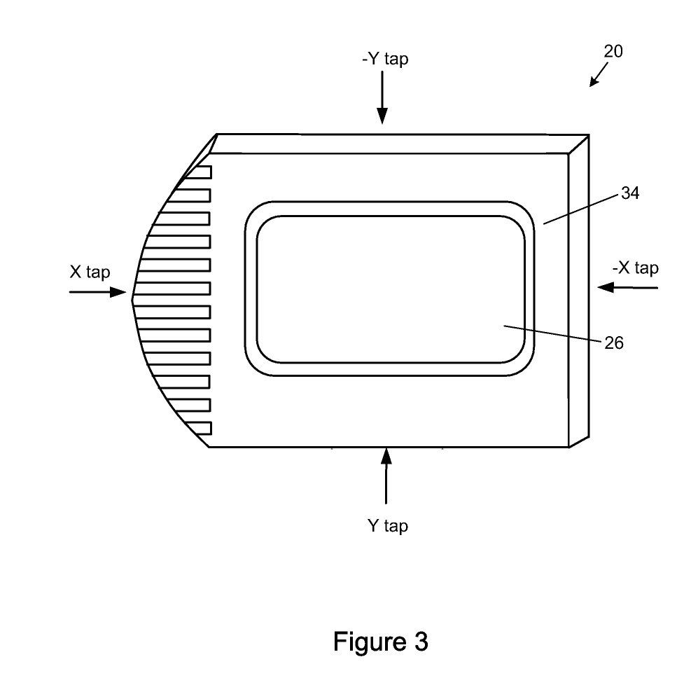

As indicated above, the electronic device 20 is suitable for underwater use and can be, for example, wrist-worn. Thus, the electronic device 20 according to the present example is sized to be worn on the wrist of a user and includes rectangular box-like housing 34, providing flat surfaces for the user to tap, such as that shown in FIGS. 2 and 3 which show an exemplary electronic device 20 for wearing on the wrist of a user according to one embodiment, and a perspective view of the housing 34 drawn to a larger scale, respectively.

Referring now to FIG. 3, the housing 34 frames the display 30 and provides a seal within which the components of the electronic device 20 are protected from water during use.

The user (diver) can tap the housing 34 with his or finger or hand in any one of several directions (denoted as +X, −X, +Y, −Y, as indicated by the arrows in FIG. 2). Further directions are possible, such as the Z direction (directly on the face of the device), as well as ‘diagonal’ directions consisting of directions oriented at various angles with respect to the cardinal direction axes. The microcontroller 26 continually analyzes the x, y, and z acceleration signals from the acceleration sensor 24 and a tap on the device creates a sudden increase in a positive or negative direction along an acceleration vector, comprised of the vector sum of the x, y and z acceleration signals, depending on the direction of the tap. The microcontroller 26 is thereby operable to detect taps on the electronic device 20, in various directions. Thus, the user taps the electronic device 20 in any one or a combination of various directions, to interact with and provide input to the electronic device 20. In one implementation, menus are used as a method of user interface. These menus are displayed on the display 30 of the electronic device 20. As the user taps the housing 34 of the electronic device 20 in different directions, the cursor in the menu is moved in different directions associated with the direction of the taps. Further, the electronic device 20 can be programmed such that a tap or a combination of taps can be interpreted as a ‘select’ operation similar to a mouse click. It will be appreciated that movements of the diver may be interpreted as taps of the device if the device is worn by the diver, for example, on the wrist.

In one exemplary embodiment, the electronic device 20 can operate in a ‘standard’ mode, as well as a separate ‘menu’ mode. Transition from the standard mode to the menu mode can be accomplished by a simple but specific sequence of taps, for example, a number of taps in a direction such as three taps in the −Y direction. A sequence such as this reduces the probability of accidental entry into menu mode via random movements of the diver.

The actual directions that the diver taps the electronic device 20, as well as the associated operations carried out in response to those taps can vary and therefore can depend on the implementation.

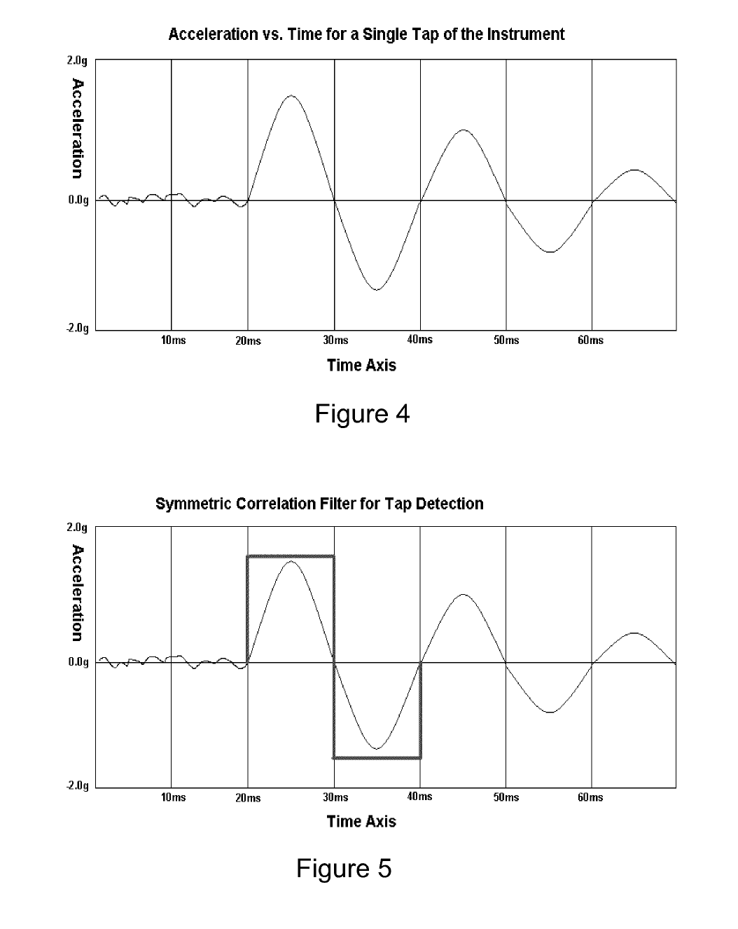

An appropriate type of acceleration sensor 24 (accelerometer) and signal processing can be determined by tapping the device and determining the response by measurement of, for example, acceleration versus time. A device tapped by a person in a typical scenario, results in an acceleration vs. time graph, such as that shown in FIG. 4. The exact characteristics of the acceleration vs. time graph depend on numerous variables including, for example, the mass of the electronic device 20, the method of tapping or hitting the electronic device 20, the relative axis or direction which the electronic device 20 is tapped or hit, and whether the electronic device 20 is worn on the wrist or hand-held. FIG. 4 is a graph of acceleration vs. time for an exemplary tap interaction with the electronic device 20. The graph shown in FIG. 4 is a general representation which may be deviated from in different situations.

Referring still to FIG. 4, the first 20 ms shows random accelerations resulting from random movements of the device. At T=20 ms, the device is tapped by the user, resulting in a sudden increase in the measured acceleration value, reaching about 1.7 g in this case. From there, the graph takes on a decaying sinusoidal characteristic, generally equivalent to an underdamped oscillator.

Although several methods of signal processing can be employed to decipher that the sudden increase in the measured acceleration value as shown in FIG. 4 represents a tap of the device, the segment from T=10 ms to T=30 ms is sufficient to determine that a tap has occurred, and to determine the direction of the tap. For accurate modeling of the fragment from T=10 ms to T=30 ms, approximately 20 acceleration samples may be used. Twenty samples over twenty milliseconds correspond to one sample per millisecond, or a sampling rate of 1000 Hz.

While softer taps can produce accelerations with peak amplitudes of about 0.8 g, very strong taps can produce accelerations approaching 6 g. Thus, the acceleration sensor 24 is used to detect accelerations in the range of 0.8 g to 6 g. In this light, a piezo accelerometer capable of measuring accelerations of only 10 g or more is not sensitive enough. However, a micromachined (MEMS) accelerometer capable of measuring ±2.0 g or a high accuracy MEMS or similar accelerometer capable of measuring ±6.0 g are possible. It should be noted that even if the peak of the acceleration graph lies outside the range of the accelerometer, the signal processing method may still be able to detect the tap correctly. Thus, a 4 g tap on a 2 g accelerometer can still be detected.

A response time for the acceleration sensor 24 (accelerometer) of about 3 ms or faster can be used, as determined from the time scale shown in FIG. 4, and the determination that 1000 samples per second is suitable. While a response time of 3 ms or faster can be used, a slower response time such as a response time of 5 ms to 6 ms is also possible with suitable programming. An acceleration sensor with a slower response time of 10 ms, for example, is not employed as the acceleration portion of the acceleration vs. time graph is not measured with such a sensor.

Given that two or three axes of acceleration are processed, each at 1000 samples per second, the supporting circuitry (analog-to-digital converter & microcontroller) is also capable of digitizing and processing data at that rate. It will be appreciated that the electronic device 20 is powered using the battery 32, power consumption of the electronic circuitry involved in tap detection is a consideration in order to provide suitable battery life.

Given the high processing power required by the microcontroller 26, a dedicated microcontroller 26, as shown in FIG. 1, can be used to process and detect the taps, while another controller, such as the microprocessor 22 shown in FIG. 1 is responsible for other operations performed by the electronic device 20. In this scenario, the microcontroller 26 signals the occurrence of a tap to the microprocessor 22 through one or more data lines connecting the two.

For wrist mounted electronic devices, tapping the device in the X or Y directions as shown in FIG. 3 results in an acceleration vs. time graph such as that shown in FIG. 4. In the X or Y directions, the electronic device 20, when worn on the wrist, is generally free to oscillate in those directions. However, when tapping or ‘knocking’ the electronic device 20 directly on the face (Z direction), a very different graph may be produced, since the device is generally not free to move in the Z direction when worn on the wrist. The graph produced may be somewhat random, and a Z direction tap can produce large oscillations in the X or Y directions, making tap detection at the microcontroller 26 difficult. The use of neoprene or other compressible material on the underside of the device is helpful in reducing this problem. The neoprene or other compressible material increases the ability to move or oscillate along the Z direction and can improve tap detection in the Z direction.

Many possible signal-processing methods can be used to detect the presence of a tap from the graph in FIG. 4.

It will be appreciated that during operation of the device, gravity is present. Gravity always produces a 1.0 g acceleration in a direction towards the center of the Earth. Thus, the direction of the gravitational acceleration vector with respect to the X, Y, and Z axes of the device depends upon the instantaneous orientation of the device with respect to the Earth itself. The gravitational vector (gravitational acceleration) is taken into account in the signal-processing method although the direction of the gravitational vector is not necessarily known. Assumptions can be made about the way the device is tapped. For example, the user taps the device along one desired direction (X, Y, or Z) at any time. Although such a tap may produce oscillations in any or all three of these axes, one axis with the strongest oscillations is assumed to be the axis through which the device was tapped. Therefore, the graphs of all allowable tap axes are analyzed, and the relative magnitude of each is compared to determine the axis with the strongest oscillations, which is the axis through which the user tapped the device. Further, the user taps the device at certain rate. For example, about two taps per second may be the limit at which a person can reliably tap the device. Therefore, after the detection of a tap along a particular axis, a ‘blackout’ period follows, during which tap detection is suspended. Tap detection resumes after a suitable period of time, for example, after 500 ms. This blackout period is employed as the tap graph is sinusoidal in nature. Since some methods may detect each sinusoidal oscillation as a separate tap, a blackout period reduces such spurious ‘multiple detections’.

The following tap detection methods are provided for exemplary purposes only and are not intended to be limiting. Any suitable tap detection method can be employed.

### The Symmetric Correlation Filter Method

According to the present exemplary method, the acceleration vs. time signal is correlated with a single square wave kernel, as shown in FIG. 5.

Assuming 1000 samples per second per axis, a 20 point circular buffer is used to store the acceleration values for each axis. Each time a new point is recorded, a square wave kernel is correlated with the data buffer. If the correlation sum is greater than an experimental threshold value, then a tap is determined to have occurred. The inverted kernel is also correlated, for detection of taps in the opposite direction, along the same axis. A similar correlation is done on other axes. The axis and direction with the greatest correlation value is determined to be the tap axis and direction. However, a ‘margin’ can be employed, so that a tap is determined to have occurred only if a correlation value exceeds other correlation values by a minimum amount. This method has the advantage that the gravitational vector is irrelevant. The gravitational vector produces a constant offset in the graph (either positive, or negative, and not more than 1.0 g). Because of the symmetrical nature of the correlation kernel, a constant offset in the graph does not change the result of the correlation. Note that the gravitational vector is only constant as an approximation. As the user moves his or her hand, the orientation of the device with respect to the gravitational vector changes. The time scale of the tap detection is so short, however, that over such a short interval, the gravitational offset appears relatively constant. This is a result of the limited rate at which a user can move his or her hand. Using the symmetric correlation method, a ‘blackout period’ after tap detection is used to reduce spurious detections resulting from each wave peak being detected as a separate tap.

### Boundary Value Method for Tap Detection

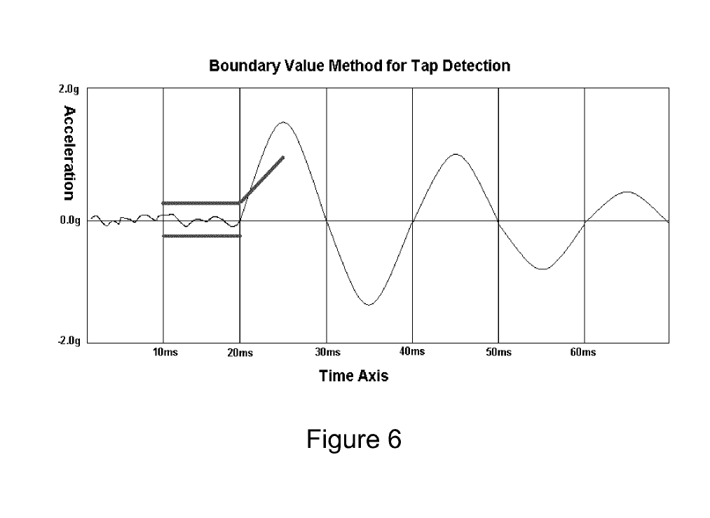

This method is based upon a simple trait of the acceleration vs. time graph. A tap is identified by a minimum period of ‘quiet’ or small acceleration values, followed by a sudden monotonically increasing acceleration beyond a peak value. Initially, for a suitable period such as, for example, 10 ms, the detected acceleration, in absolute values, remain small and are bounded by experimental thresholds such as those shown between T=10 ms and T=20 ms in FIG. 6. After the minimum period of ‘quiet’ or relatively small acceleration values, the acceleration values are compared against a ramp. Only when acceleration values are greater or ‘above’ this ramp is a tap determined to have occurred. When all conditions are satisfied, including the minimum period of ‘quiet’ and the occurrence of acceleration values greater than the ramp, then a tap is determined to have occurred. A separate (symmetrically inverted) analysis is done to detect taps along the same axis in the opposite direction. The analysis is performed on all axes, and the values of each axis compared. This method does not include automatic gravitational compensation. Instead, the gravitational vector is deliberately removed. One method of removing the gravitational vector is based on the gravitational offset being relatively constant when measured over a short time scale such as, for example, 100 ms. Further, accelerations induced by motion will average to zero over a similar timescale. Thus, by averaging the measured acceleration values over a period of, for example, about 100 ms the gravitational offset can be deduced, and then subtracted from the analyzed signal.

Many other methods of detecting the presence of taps are possible.

### Exemplary Implementation

The following exemplary implementation is provided for the purpose of understanding and is not intended to be limiting. The implemented system includes many components, three suitable components for one exemplary implementation are described below. These include the acceleration sensor 24, the microcontroller 26 and the processor 22.

The acceleration sensor 24 can be a Freescale MMA7260Q three-axis MEMS accelerometer including adjustable ranges of ±1.5 g, ±2.0 g, ±4.0 g, ±6.0 g and a suitable response time of 3 dB Bandwidth of 350 Hz.

The microcontroller 26 can be a Texas Instruments device MSP430F1232, 16-bit ultra-low power microcontroller having a multi-channel 10-bit analog to digital converter with up to 8 MHz CPU frequency and 8 MIPS processing speed along with 8 KB of flash program memory.

The processor 22 can be a Philips LPC2138, 32-bit ARM7 core, 512K program flash memory with up to 60 MHz operating frequency.

The MMA7260Q three-axis MEMS accelerometer can output analog values proportional to the acceleration along the x, y and z axes. These analog signals can be fed into the MSP430F1232, 16-bit ultra-low power microcontroller. The 10-bit analog to digital converter in the MSP430F1232, 16-bit ultra-low power microcontroller can digitize each of the three channels at 1000 samples per second. The MSP430F132, 16-bit ultra-low power microcontroller processes the signal (as described above). Upon the detection of a tap, the MSP430F1232, 16-bit ultra-low power microcontroller activates an interrupt signal line to the LPC2138 processor 20, and at the same time, the type of tap (+X, −X, +Y, −Y, +Z, −Z) is encoded in four other signal lines. The LPC2138 primary microcontroller reads pressure information from a pressure sensor, and calculates the diver's depth and dive time, displaying them on the display 30 visible to the user.

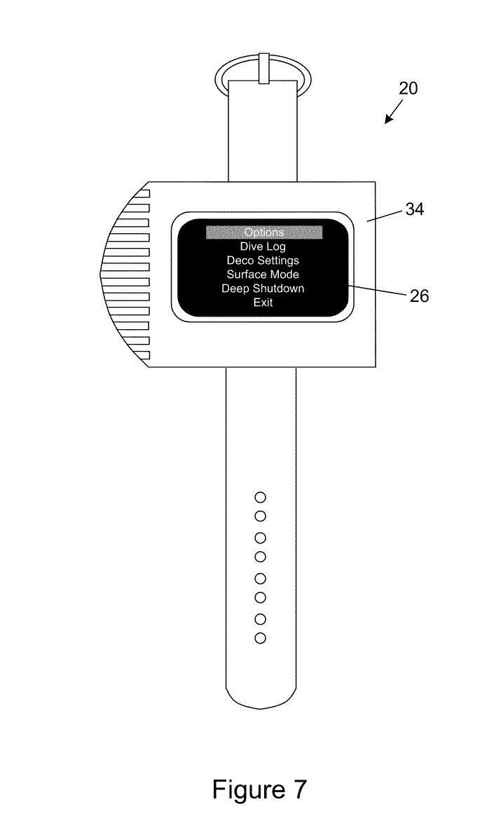

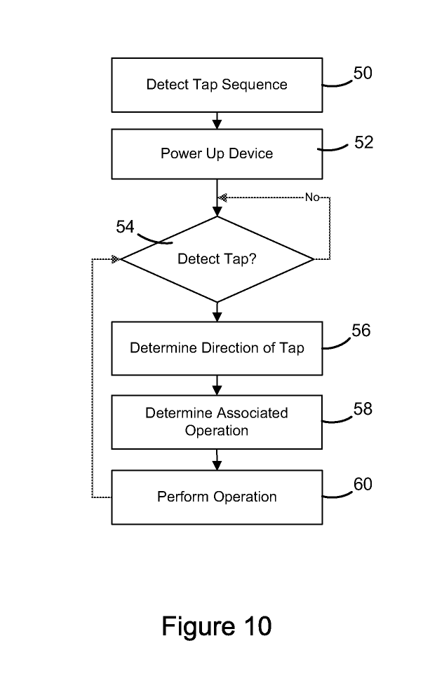

Reference is now made to FIG. 10 to describe an exemplary method of controlling an electronic device 20 for underwater use according to an embodiment. With the electronic device 20 in a low-power or “sleep” mode, a tap sequence can be used in which the user taps the electronic device 20 any suitable number of times in any suitable sequence to “wake up” the electronic device 20. The tap sequence is detected at step 50 and the electronic device 20 powers up to provide a display such as the menu display shown in FIG. 7 (step 52). Next, a tap is detected using, for example, a tap detection method as described above (step 54) and the primary axis of the direction of the tap is determined (step 56). The operation to be performed based on the direction of the tap is determined by matching the detected tap direction to an operation (step 58). For example, the operation may be to navigate a menu by moving a cursor on the display 30. Alternatively, the operation may be to select a highlighted menu option. The determined operation is then performed by, for example, navigating the menu or selecting an option or any other suitable operation.

As indicated above, when the electronic device 20 is in a low-power state, the user can wake up the electronic device 20 by, for example, three or five consecutive taps in the −Y direction shown in FIG. 3 (step 50). The number of taps required, such as 3 or 5, can be any suitable number of taps and can be pre-set or set by the user. By using a number of taps in sequence, the chance of accidental powering on of the electronic device 20 is reduced. Once the electronic device 20 is powered on, a menu can be displayed for user-navigation (step 52). An exemplary screen shot of a menu on the electronic device 20 is shown in FIG. 7.

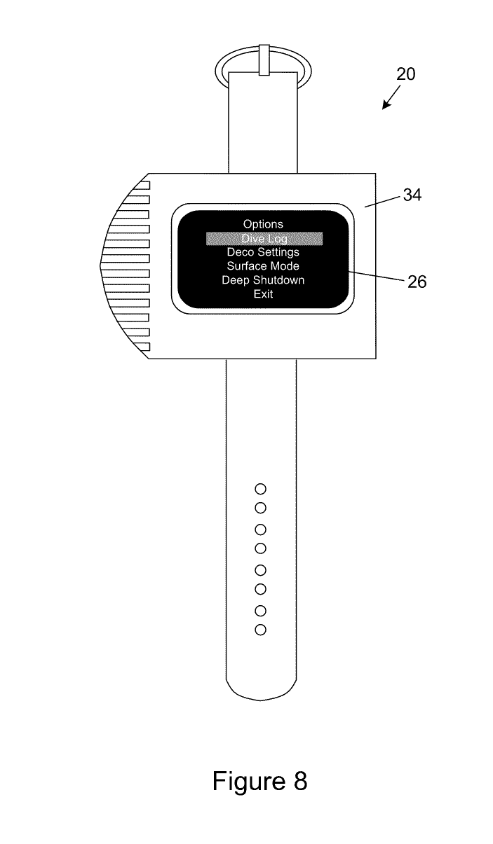

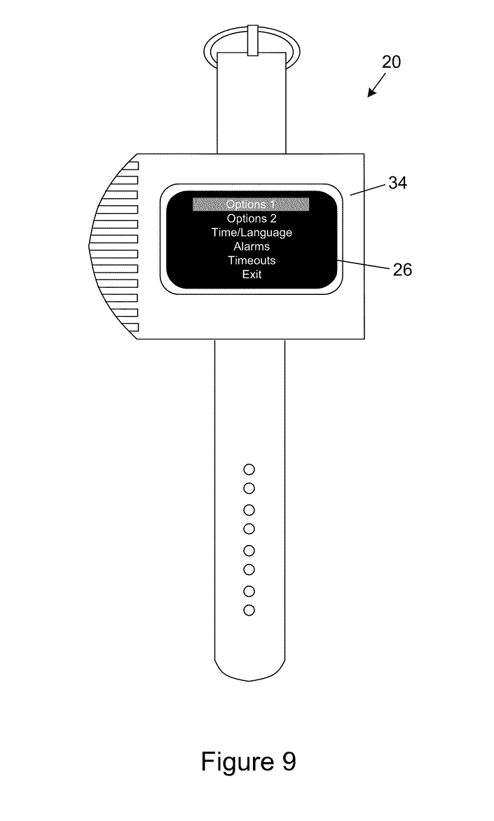

In the example of FIG. 7, the first user-selectable item in the menu list is highlighted. The highlighted user-selectable item (or item on which the ‘cursor’ resides) indicates the current or active menu item. When the user taps the device, the tap is determined and the device responds accordingly. For example, when the user taps the device in the −Y direction (see FIG. 3), the tap is detected (step 54), the direction of tap is determined (step 56) and the associated operation is then determined to be a cursor movement (step 58). The cursor then moves down to the next menu item, as shown in the screen shot of FIG. 8 (step 58). If the user now taps the device in the +Y direction (see FIG. 3), then the direction of tap is determined along with the associated operation. The cursor then moves back up to the position shown in FIG. 7. If the user taps the device in EITHER the +X or −X directions, this action can ‘select’ or ‘click’ on the active menu item, causing the electronic device 20 to enter a sub-menu related to the menu selection, which in the present example is the ‘Options’ sub menu, as shown in FIG. 9.

In the present example, an item is selected by a user by tapping in either the +X or −X directions. This symmetry allows for the user to use the device on either the left hand or the right hand, based on which arm the device is worn. The symmetry of the ‘select’ action therefore allows the user the freedom to choose which side of the unit he or she taps, to select the item.

Advantageously, the present invention allows for interaction with and control of the electronic device even when thick diving gloves are worn. The menu navigation is accomplished by tapping the device and without the use of buttons or complicated button-pressing. The method allows taps in relatively quick succession, resulting in an improved interaction speed as compared to that of buttons. Further, the device can be ‘potted’ or filled with a semi rigid epoxy, creating a hermetic seal against the ocean water as there are no internal moving parts. This reduces the risk of flooding and failure that occurs with traditional devices.

In the preceding description, for purposes of explanation, numerous details are set forth in order to provide a thorough understanding of the embodiments of the present application. However, it will be apparent to one skilled in the art that certain specific details are not required. In other instances, features, including functional features, are shown in block diagram form in order not to obscure the description. Further, certain Figures and features are simplified for ease of understanding. In some cases, for example, specific details are not provided as to whether the embodiments described herein are implemented as a software routine, hardware circuit, firmware, or a combination thereof.

While the embodiments described herein are directed to particular implementations of the diving device, it will be understood that modifications and variations to these embodiments are within the scope and sphere of the present application. For example, many of the options provided in menus and submenus and the details displayed in the screen shots provided are shown for exemplary purposes and such options and details can vary.

The above-described embodiments are intended to be examples only. Alterations, modifications and variations can be effected to the particular embodiments by those of skill in the art without departing from the scope of the present application, which is defined by the claims appended hereto.

1. An electronic device for underwater use, the device comprising
a housing for sealing internal components therein;
a display device framed by the housing;
an accelerometer housed in the housing; and
a controller connected to the accelerometer and the display device and housed in the housing, the controller for receiving signals from the accelerometer, determining a user-interaction event based on the signals received from the accelerometer, and performing an operation in response to the interaction event.

2. The electronic device according to claim 1, wherein the user-interaction event comprises a user tapping the housing of the electronic device.

3. The electronic device according to claim 2, wherein the accelerometer is a three-axis accelerometer for determining user-tapping in more than one direction.

4. The electronic device according to claim 3, wherein user-tapping in a first direction results in performance of a first operation and user-tapping in a second direction results in performance of a second operation, the first operation being different from the second operation.

5. The electronic device according to claim 1, wherein the operation comprises navigation of a screen displayed on the display device.

6. The electronic device according to claim 1, wherein the operation comprises one of causing a display change upon powering up of the electronic device, movement of a cursor in a menu-list of items and selection of one of said items from said menu-list.

7. The electronic device according to claim 1, wherein the controller comprises first and second controllers, the first controller for receiving the signals from the accelerometer, detecting the user-interaction event and signaling to the second controller, the occurrence of the user-interaction event, the second controller performing said operation.

8. The electronic device according to claim 7, comprising a pressure sensor connected to the controller for determining an underwater depth for display on the display device.

9. The electronic device according to claim 1, comprising a fill material within the housing for providing a hermetic seal.

10. The electronic device according to claim 9, wherein the fill material comprises an epoxy.

11. The electronic device according to claim 10, wherein the epoxy is semi-rigid when cured.

12. A method of controlling an electronic device for underwater use, the method comprising:
detecting a user-interaction with the electronic device based on signals received from an accelerometer; and
performing an operation in response to detecting the user-interaction.

13. The method according to claim 12, wherein performing the operation comprises causing a change in a display device of the underwater device.

14. The method according to claim 13, wherein detecting the user-interaction comprises detecting a user tap on the underwater device.

15. The method according to claim 14, comprising determining a direction of the user tap on the underwater device prior to performing said operation.

16. The method according to claim 15, wherein performing the operation comprises performing one of multiple operations, dependent on the direction of the user tap.

17. The method according to claim 15, wherein performing an operation comprises navigating a screen displayed on the display device.

18. The method according to claim 15, wherein performing the operation comprises one of causing a display change upon powering up of the electronic device, movement of a cursor in a menu-list of items and selection of one of said items from said menu-list.
